(19) United States
(12) Patent Application Publication
(10) Pub. No.: US 2015/0373535 A1
(43) Pub. Date: Dec. 24, 2015

(54) Method, Apparatus, and System for Managing Device

(71) Applicant: Huawei Technologies Co., Ltd., Shenzhen (CN)

(72) Inventors: Jiejing Huang, Shenzhen (CN); Huangwei Wu, Shenzhen (CN); Zhe Xu, Shenzhen (CN)

(21) Appl. No.: 14/730,664

(22) Filed: Jun. 4, 2015

Related U.S. Application Data
(63) Continuation of application No. PCT/CN2014/080608, filed on Jun. 24, 2014.

(51) Int. Cl. H04W 8/24; H04W 4/00

(52) U.S. Cl. CPC H04W 8/245; H04W 4/001

(57) ABSTRACT

A method for managing a device comprising a server receives a device transfer request message, where the device transfer request message includes transferee information of the device and information about the device; a to-be-transferred instruction is sent to the device according to the device transfer request message, where the to-be-transferred instruction includes the transferee information of the device; the to-be-transferred instruction is used to instruct the device to set an activated state of the device to a to-be-activated state; and after the device is set to the to-be-activated state, the device can be activated only by using specified user information, where the specified user information includes transferor information of the device and/or the transferee information of the device.

### CROSS-REFERENCE TO RELATED APPLICATION

This application is a continuation of PCT Application No. PCT/CN2014/080608, filed on Jun. 24, 2014, which is incorporated herein by reference in its entirety.

### TECHNICAL FIELD

Embodiments of the present invention relate to the field of communications technologies, and in particular, to a method, an apparatus, and a system for managing a device.

### BACKGROUND

A kill switch for mobile phone anti-theft mainly refers to that, after a mobile phone of a user is stolen, an authorized user may remotely perform a destructive operation on the stolen mobile phone, and the operation is similar to remotely locking the mobile phone, remotely erasing all user data on the mobile phone, and making the stolen mobile phone unavailable.

However, although a function of a kill switch can effectively suppress an illegal second-hand transfer of a mobile phone and crack down on a theft behavior, the function of the kill switch may probably be inappropriately used by a user. For example, when a device transferor legally transfers a mobile phone of the device transferor to a device transferee, the device transferor may still maliciously and remotely perform the function of the kill switch on the mobile phone and cause data of the legal device transferee to be maliciously cleared, thereby directly threatening security for using the mobile phone by the device transferee.

Therefore, in an existing mobile phone anti-theft technology, security for using a mobile phone by a legal transferee cannot be ensured.

### SUMMARY

Embodiments of the present invention provide a method, an apparatus, and a system for managing a device. When a transferor of a device legally transfers the device to a transferee of the device, the device is set to a to-be-activated state, so that the transferor of the device cannot maliciously clear data of the transferee of the device, and therefore, security for using the device by the transferee of the device is ensured.

According to a first aspect, the present invention provides a method for managing a device, where a binding relationship between the device and transferor information of the device is stored in a server, and the method includes receiving, by the server, a device transfer request message, where the device transfer request message includes transferee information of the device and information about the device, and sending, by the server, a to-be-transferred instruction to the device according to the device transfer request message, where the to-be-transferred instruction includes the transferee information of the device; the to-be-transferred instruction is used to instruct the device to set an activated state of the device to a to-be-activated state; and after the device is set to the to-be-activated state, the device can be activated only by using specified user information, where the specified user information includes the transferor information of the device and/or the transferee information of the device.

Optionally, after the sending, by the server, a to-be-transferred instruction to the device according to the device transfer request message, the method further includes receiving, by the server, a first activation request message sent by the device, where the first activation request message includes the transferee information of the device and the information about the device, and deleting, by the server according to the first activation request message, the binding relationship between the device and the transferor information of the device stored in the server, and establishing, by the server, a binding relationship between the device and the transferee information of the device according to the first activation request message.

Optionally, after the establishing, by the server, a binding relationship between the device and the transferee information of the device, the method further includes sending, by the server, a first activation instruction to the device, where the first activation instruction is used to instruct the device to delete user data of a transferor of the device saved in the device and use the transferee information of the device to activate the device.

Optionally, after the sending, by the server, a to-be-transferred instruction to the device according to the device transfer request message, the method further includes receiving, by the server, a second activation request message sent by the device, where the second activation request message includes the transferor information of the device and the information about the device, and sending, by the server, a second activation instruction to the device, where the second activation instruction is used to instruct the device to use the transferor information of the device to activate the device.

Optionally, the sending, by the server, a to-be-transferred instruction to the device according to the device transfer request message includes sending, by the server according to the transferee information of the device, a transfer acknowledgement request message to a terminal of a transferee to which the transferee information points, so that the terminal of the transferee sends a transfer acknowledgement response message to the server, and sending, by the server, the to-be-transferred instruction to the device according to the transfer acknowledgement response message.

According to a second aspect, an apparatus for managing a device is provided, where the apparatus is located on a server side, a binding relationship between the device and transferor information of the device is stored in a server, and the apparatus includes a receiving module, configured to receive a device transfer request message, where the device transfer request message includes transferee information of the device and information about the device, and a sending module, configured to send a to-be-transferred instruction to the device according to the device transfer request message, where the to-be-transferred instruction includes the transferee information of the device; the to-be-transferred instruction is used to instruct the device to set an activated state of the device to a to-be-activated state; and after the device is set to the to-be-activated state, the device can be activated only by using specified user information, where the specified user information includes the transferor information of the device and/or the transferee information of the device.

Optionally, the receiving module is further configured to receive a first activation request message sent by the device, where the first activation request message includes the transferee information of the device and the information about the device, and the apparatus further includes a deleting module, configured to delete, according to the first activation request message, the binding relationship between the device and the transferor information of the device stored in the server, and an establishing module, configured to establish a binding relationship between the device and the transferee information of the device according to the first activation request message.

Optionally, the sending module is further configured to send a first activation instruction to the device, where the first activation instruction is used to instruct the device to delete user data of a transferor of the device saved in the device and use the transferee information of the device to activate the device.

Optionally, the receiving module is further configured to receive a second activation request message sent by the device, where the second activation request message includes the transferor information of the device and the information about the device, and the sending module is further configured to send a second activation instruction to the device, where the second activation instruction is used to instruct the device to use the transferor information of the device to activate the device.

Optionally, the sending module is further configured to send, according to the transferee information of the device, a transfer acknowledgement request message to a terminal of a transferee to which the transferee information points, so that the terminal of the transferee sends a transfer acknowledgement response message to the server, and the sending module is further configured to send the to-be-transferred instruction to the device according to the transfer acknowledgement response message.

According to a third aspect, an apparatus for managing a device is provided, where the apparatus is located on a server side, a binding relationship between the device and transferor information of the device is stored in a server, and the apparatus includes a processor and a memory, where the processor and the memory are connected by using a communications bus; an instruction for implementing the method for managing a device according to the first aspect is saved in the memory; and the processor may invoke the instruction in the memory to execute the method for managing a device according to the first aspect.

According to a fourth aspect, a method for managing a device is provided, where a binding relationship between the device and transferor information of the device is stored in a server, and the method includes receiving, by the device, a to-be-transferred instruction sent by the server, where the to-be-transferred instruction includes transferee information of the device; and setting, by the device, an activated state of the device to a to-be-activated state according to the to-be-transferred instruction, where the to-be-transferred instruction is a to-be-transferred instruction that is sent by the server, after receiving a device transfer request message, to the device according to the transferee information of the device and information about the device that are included in the device transfer request message.

Optionally, after the setting, by the device, an activated state of the device to a to-be-activated state, the method includes sending, by the device, a first activation request message to the server, where the first activation request message includes the transferee information of the device and the information about the device, so that the server deletes, according to the first activation request message, the binding relationship between the device and the transferor information of the device stored in the server, and establishes a binding relationship between the device and the transferee information of the device according to the first activation request message.

Optionally, the method further includes receiving, by the device, a first activation instruction sent by the server, and deleting, by the device according to the first activation instruction, user data of a transferor of the device saved in the device, and using, according to the first activation instruction, the transferee information of the device to activate the device.

Optionally, after the setting, by the device, an activated state of the device to a to-be-activated state, the method further includes sending, by the device, a second activation request message to the server, where the second activation request message includes the transferor information of the device and the information about the device, so that the server sends a second activation instruction to the device, where the second activation instruction is used to instruct the device to use the transferor information of the device to activate the device, and using, by the device according to the second activation instruction, the transferor information of the device to activate the device.

According to a fifth aspect, an apparatus for managing a device is provided, where the apparatus is located on a device side, a binding relationship between the device and transferor information of the device is stored in a server, and the apparatus includes a receiving module, configured to receive a to-be-transferred instruction sent by the server, where the to-be-transferred instruction includes transferee information of the device, and a setting module, configured to set an activated state of the device to a to-be-activated state according to the to-be-transferred instruction, where the to-be-transferred instruction is a to-be-transferred instruction that is sent by the server, after receiving a device transfer request message, to the device according to the transferee information of the device and information about the device that are included in the device transfer request message.

Optionally, the apparatus further includes a sending module, configured to send a first activation request message to the server, where the first activation request message includes the transferee information of the device and the information about the device, so that the server deletes, according to the first activation request message, the binding relationship between the device and the transferor information of the device stored in the server, and establishes a binding relationship between the device and the transferee information of the device according to the first activation request message.

Optionally, the receiving module is further configured to receive a first activation instruction sent by the server, and the apparatus further includes a deleting module, configured to delete, according to the first activation instruction, user data of a transferor of the device saved in the device, and an activating module, configured to use, according to the first activation instruction, the transferee information of the device to activate the device.

Optionally, the sending module is further configured to send a second activation request message to the server, where the second activation request message includes the transferor information of the device and the information about the device, so that the server sends a second activation instruction to the device, where the second activation instruction is used to instruct the device to use the transferor information of the device to activate the device, and the activating module is further configured to use, according to the second activation instruction, the transferor information of the device to activate the device.

According to a sixth aspect, an apparatus for managing a device is provided, where the apparatus is located on a device side, a binding relationship between the device and transferor information of the device is stored in a server, and the apparatus includes a processor and a memory, where the processor and the memory are connected by using a communications bus; an instruction for implementing the method for managing a device according to the fifth aspect is saved in the memory; and the processor may invoke the instruction in the memory to execute the method for managing a device according to the fifth aspect.

According to a seventh aspect, a system for managing a device is provided, where the system includes a server and a device that is connected to the server, where the server includes the apparatus for managing a device according to the second aspect, and the device includes the apparatus for managing a device according to the fifth aspect.

A server in the embodiments of the present invention receives a device transfer request message, where the device transfer request message includes transferee information of a device and information about the device; a to-be-transferred instruction is sent to the device according to the device transfer request message, where the to-be-transferred instruction includes the transferee information of the device; the to-be-transferred instruction is used to instruct the device to set an activated state of the device to a to-be-activated state; and after the device is set to the to-be-activated state, the device can be activated only by using specified user information, where the specified user information includes transferor information of the device and/or the transferee information of the device. In this way, by using the technical solutions described in the embodiments of the present invention, when a transferor of a device legally transfers the device to a transferee of the device, the device is set to a to-be-activated state, so that the transferor of the device cannot maliciously clear data of the transferee of the device, and therefore, security for using the device by the transferee of the device is ensured.

### BRIEF DESCRIPTION OF DRAWINGS

To describe the technical solutions in the embodiments of the present invention more clearly, the following briefly introduces the accompanying drawings required for describing the embodiments or the prior art. The accompanying drawings in the following description show some embodiments of the present invention, and persons of ordinary skill in the art may still derive other drawings from these accompanying drawings without creative efforts.

FIG. 1 is a schematic flowchart of a method for managing a device according to an embodiment of the present invention.

FIG. 2 is a signaling diagram of a method for managing a device according to another embodiment of the present invention.

FIG. 3 is a schematic structural diagram of an apparatus for managing a device according to an embodiment of the present invention.

FIG. 4 is a schematic structural diagram of a server according to an embodiment of the present invention.

FIG. 5 is a schematic structural diagram of an apparatus for managing a device according to an embodiment of the present invention.

FIG. 6 is a schematic structural diagram of a device according to an embodiment of the present invention.

FIG. 7 is a schematic structural diagram of a system for managing a device according to an embodiment of the present invention.

### DESCRIPTION OF EMBODIMENTS

To make the objectives, technical solutions, and advantages of the embodiments of the present invention clearer, the following clearly describes the technical solutions in the embodiments of the present invention with reference to the accompanying drawings in the embodiments of the present invention. The described embodiments are some but not all of the embodiments of the present invention. All other embodiments obtained by persons of ordinary skill in the art based on the embodiments of the present invention without creative efforts shall fall within the protection scope of the present invention.

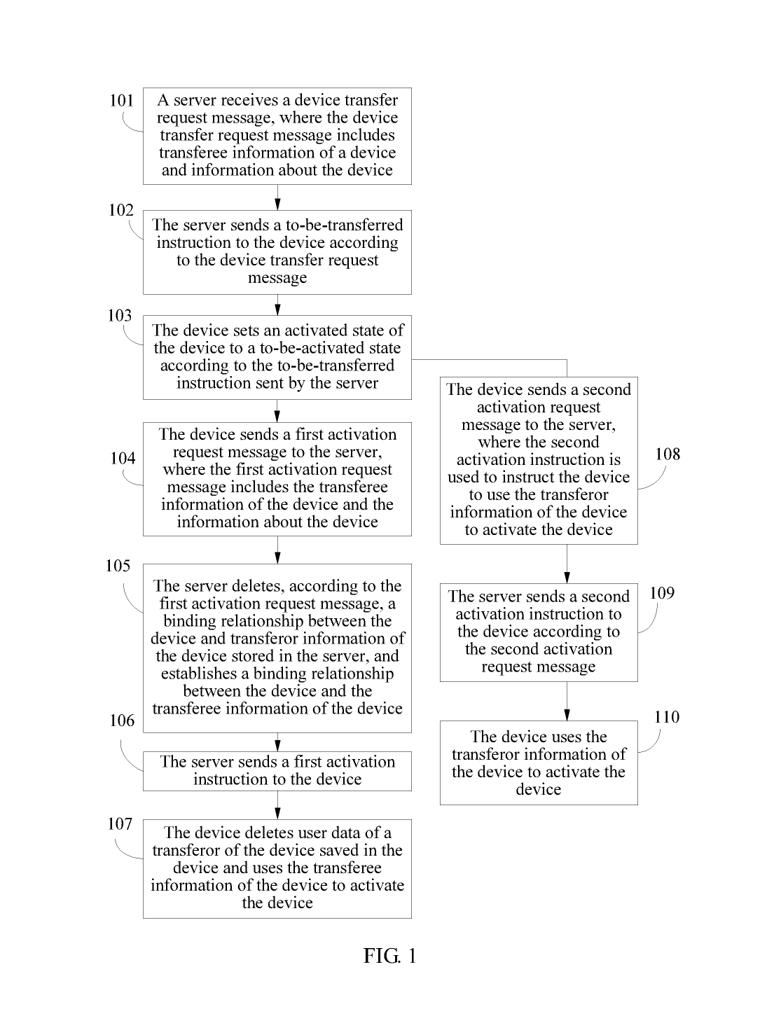

FIG. 1 is a schematic flowchart of a method for managing a device according to an embodiment of the present invention. As shown in FIG. 1, the method includes:

101. A server receives a device transfer request message, where the device transfer request message includes transferee information of the device and information about the device.

The server may receive the device transfer request message from a device that is used by a transferor of the device.

The transferee information of the device includes, for example, a user name of a transferee (for example, if the device is an APPLE device, the transferee information is an APPLE identification (ID) of the transferee; and if the device is an ANDROID device, the transferee information is a GOOGLE account of the transferee).

Transferor information of the device includes, for example, a user name of the transferor, and the information about the device is, for example, an identity that uniquely identifies the device.

It should be noted that, before step 101, the method further includes the following:

The transferor of the device sends a third activation request message to the server by using the device, where the third activation request message includes the transferor information of the device and the information about the device.

The server establishes and saves a binding relationship between the transferor information and the information about the device according to the third activation request message.

Afterward, the server sends a third activation instruction to the device, where the third activation instruction is used to instruct the device to use the transferor information to activate the device, and then the device may save data generated when the transferor uses the device.

102. The server sends a to-be-transferred instruction to the device according to the device transfer request message.

The to-be-transferred instruction includes the transferee information of the device; the to-be-transferred instruction is used to instruct the device to set an activated state of the device to a to-be-activated state; and after the device is set to the to-be-activated state, the device can be activated only by using specified user information, where the specified user information includes the transferor information of the device and/or the transferee information of the device.

Optionally, during specific implementation, step 102, for example, includes sending, by the server according to the transferee information of the device, a transfer acknowledgement request message to a terminal of the transferee to which the transferee information points, so that the terminal of the transferee sends a transfer acknowledgement response message to the server; and sending, by the server, the to-be-transferred instruction to the device according to the transfer acknowledgement response message.

The terminal of the transferee may be, for example, a device that is used by the transferee.

In this embodiment of the present invention, it is assumed that ID information of the transferee is an email address of the transferee, the server may send, to the email address of the transferee, an email carrying the transfer acknowledgement request message, and the transferee may use the email address of the transferee to receive the email carrying the transfer acknowledgement request message and reply to the server by sending an email carrying the transfer acknowledgement response message.

103. The device sets an activated state of the device to a to-be-activated state according to the to-be-transferred instruction sent by the server.

In this case, the device is in the to-be-activated state, and the device can be activated only according to specified user information, where the specified user information includes the transferor information of the device and/or the transferee information of the device. For example, when a transaction succeeds, the device may be activated by using the transferee information, or when a transaction fails, the device may be activated by using the transferor information. Even if the device is stolen or lost, a third person cannot activate or use the device.

When a device transfer succeeds, the transferee may request activation of the device from the server by using the device, and after step 103, the method includes:

104. The device sends a first activation request message to the server, where the first activation request message includes the transferee information of the device and the information about the device.

105. The server deletes, according to the first activation request message, the binding relationship between the device and the transferor information of the device stored in the server, and establishes a binding relationship between the device and the transferee information of the device.

106. The server sends a first activation instruction to the device.

The first activation instruction is used to instruct the device to delete user data of the transferor of the device saved in the device and use the transferee information of the device to activate the device.

107. The device deletes the user data of the transferor of the device saved in the device and uses the transferee information of the device to activate the device.

When the device transfer does not succeed, the transferor may request re-activation of the device from the server by using the device, and after step 103, the method further includes:

108. The device sends a second activation request message to the server, where the second activation request message includes the transferor information of the device and the information about the device.

109. The server sends a second activation instruction to the device according to the second activation request message.

The second activation instruction is used to instruct the device to use the transferor information of the device to activate the device.

110. The device uses the transferor information of the device to activate the device.

A server in this embodiment of the present invention receives a device transfer request message, where the device transfer request message includes transferee information of the device and information about the device; a to-be-transferred instruction is sent to the device according to the device transfer request message, where the to-be-transferred instruction includes the transferee information of the device; the to-be-transferred instruction is used to instruct the device to set an activated state of the device to a to-be-activated state; and after the device is set to the to-be-activated state, the device can be activated only by using specified user information, where the specified user information includes transferor information of the device and/or the transferee information of the device. In this way, by using the technical solution described in this embodiment of the present invention, when a transferor of a device legally transfers the device to a transferee of the device, the device is set to a to-be-activated state, so that the transferor of the device cannot maliciously clear data of the transferee of the device, and therefore, security for using the device by the transferee of the device is ensured.

That the device is an IPHONE and the server is an ICLOUD is used as an example in the following to describe a specific procedure of this embodiment of the present invention in detail. It should be noted that, the device described in this embodiment of the present invention includes but is not limited to an APPLE product, and the server described in this embodiment of the present invention includes but is not limited to the ICLOUD. For example, the device may also be an ANDROID mobile phone, and the server may also be a GOOGLE Play server.

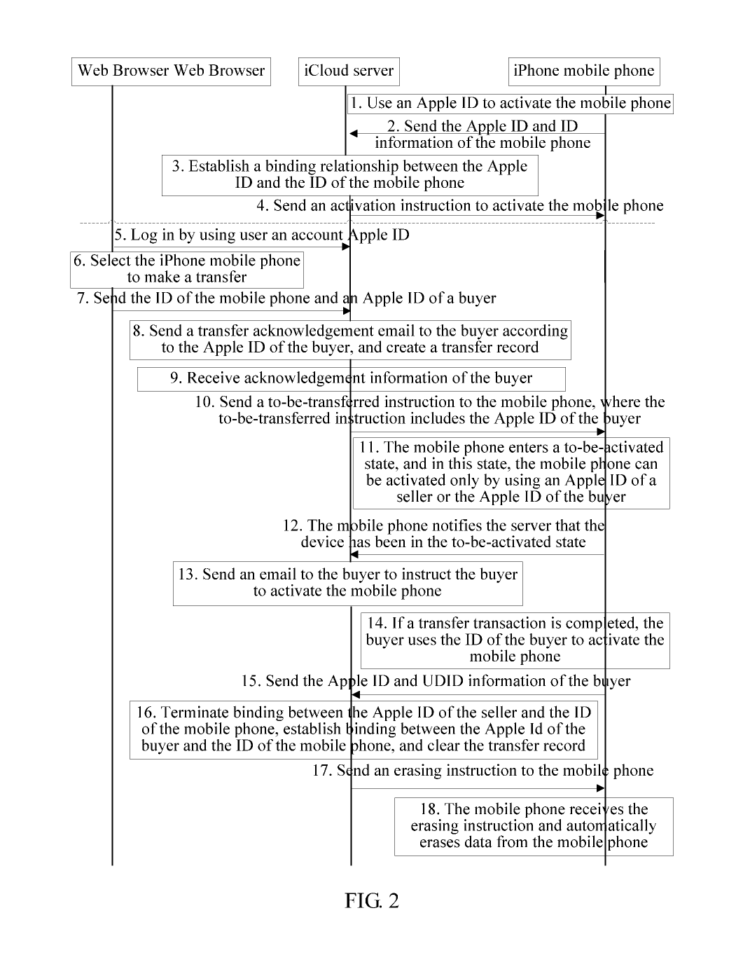

FIG. 2 is a signaling diagram of a method for managing a device according to another embodiment of the present invention. As shown in FIG. 2, the method in this embodiment may include the following.

1. A seller uses APPLE ID information of the seller to request online activation of an IPHONE mobile phone. The APPLE ID information of the seller is an APPLE ID and a password. During activation, the APPLE ID information of the seller is sent to a server for activation. After the IPHONE mobile phone is activated, the server stores a binding relationship between the APPLE ID information of the seller and ID information of the IPHONE mobile phone.

2. The IPHONE mobile phone sends the APPLE ID information of the seller and the ID information of the IPHONE mobile phone to an ICLOUD server.

3. After the ICLOUD server verifies the received APPLE ID information of the seller successfully, the ICLOUD server establishes and stores a binding relationship between the APPLE ID information of the seller and the ID information of the IPHONE mobile phone.

4. The ICLOUD server sends an activation instruction to the IPHONE mobile phone, where the activation instruction is used to instruct the IPHONE mobile phone to use the APPLE ID information of the seller to activate the IPHONE mobile phone.

After step 4, the ICLOUD server establishes the binding relationship between the APPLE ID information of the seller and the ID information of the IPHONE mobile phone. Then, the IPHONE mobile phone can be normally used.

5. The seller uses the APPLE ID of the seller to log in to the ICLOUD server by using a web browser.

6. The seller selects, by using the web browser, a device to make a transfer.

For example, the seller selects, by using the web browser, the IPHONE mobile phone that is activated in step 1 to make a transfer, and meanwhile, the seller needs to provide APPLE ID information of a buyer who buys the IPHONE mobile phone.

7. The web browser sends a transfer request to the ICLOUD server, where the transfer request includes the ID information of the IPHONE mobile phone and the ID information of the buyer.

8. The ICLOUD server sends a notification email to the buyer according to the APPLE ID information of the buyer in the transfer request.

For example, the notification email includes a uniform resource locator (URL), so that after receiving the notification email, the buyer acknowledges, by clicking the URL, that the buyer agrees to buy the device.

9. The ICLOUD server receives acknowledgement information of the buyer.

The ICLOUD server can determine an identity of the buyer and continue to perform a transfer operation.

10. The ICLOUD server sends a to-be-transferred instruction to the IPHONE mobile phone, where the to-be-transferred instruction includes the APPLE ID information of the buyer.

11. The IPHONE mobile phone enters a to-be-activated state according to the received to-be-transferred instruction sent by the ICLOUD server.

When the device enters the to-be-activated state, the device can perform online activation only by using the APPLE ID information of the seller or the APPLE ID information of the buyer.

12. At the same time when the IPHONE mobile phone enters the to-be-activated state, the IPHONE mobile phone sends acknowledgement information to notify the ICLOUD server that the IPHONE mobile phone has entered the to-be-activated state.

13. After receiving the acknowledgement information from the IPHONE mobile phone, the ICLOUD server sends an email to the buyer and notifies the buyer that the buyer can use the APPLE ID information of the buyer to activate the IPHONE mobile phone.

14. After receiving the email, the buyer can enter the APPLE ID information of the buyer on the IPHONE mobile phone to request online activation of the IPHONE mobile phone.

15. The IPHONE mobile phone sends the APPLE ID information of the buyer and the ID information of the IPHONE mobile phone to the ICLOUD server.

16. After the ICLOUD server receives the APPLE ID information of the buyer and the ID information of the IPHONE mobile phone that are sent by the IPHONE mobile phone, and verifies the APPLE ID information of the buyer successfully, the ICLOUD server terminates the binding relationship between the APPLE ID information of the seller and the ID information of the IPHONE mobile phone, and establishes a binding relationship between the APPLE ID information of the buyer and the ID information of the IPHONE mobile phone.

17. The ICLOUD server sends a transfer activation instruction to the IPHONE mobile phone, where the transfer activation instruction is used to instruct the IPHONE mobile phone to erase user data of the seller from the IPHONE mobile phone and use the APPLE ID information of the buyer to activate the IPHONE mobile phone.

18. The IPHONE mobile phone erases the user data of the seller from the IPHONE mobile phone according to the received transfer activation instruction sent by the ICLOUD server, and uses the APPLE ID information of the buyer to activate the IPHONE mobile phone.

It should be noted that, it is assumed that the transfer does not succeed, in the foregoing step 14, the APPLE ID information for activating the IPHONE mobile phone is the APPLE ID information of the seller; in step 15, activation information sent by the IPHONE mobile phone is the APPLE ID information of the seller and the ID information of the IPHONE mobile phone; in step 16, the ICLOUD server still reserves the binding relationship between the APPLE ID information of the seller and the ID information of the IPHONE mobile phone, and the IPHONE mobile phone is activated by using the APPLE ID information of the seller; in step 17, the ICLOUD server sends the activation instruction to the IPHONE mobile phone, where the activation instruction is used to activate the IPHONE mobile phone only by using the APPLE ID information of the seller, and the user data of the seller reserved in the IPHONE mobile phone is not erased; and in step 18, after receiving the activation instruction, the IPHONE mobile phone only uses the APPLE ID information of the seller to activate the IPHONE mobile phone, and the user data of the seller reserved in the IPHONE mobile phone is not erased.

In the foregoing, that the device is an IPHONE and the server is an ICLOUD is used as an example to describe the specific procedure of this embodiment of the present invention in detail. When a seller requests a device transfer from a server, a to-be-transferred instruction may be sent to a device by the server, so as to enable the device to be in a to-be-activated state. User information of a buyer can be used to activate the device only when a transaction succeeds, or user information of the seller can be used to activate the device only when a transaction does not succeed. Even if the device is stolen or lost, a third person cannot activate or use the device. When the transaction succeeds, the server deletes a correspondence between the user information of the seller and information about the device, so that the seller making a legal transfer cannot maliciously clear user data of the buyer, and therefore, security for using the transferred device by the buyer is ensured.

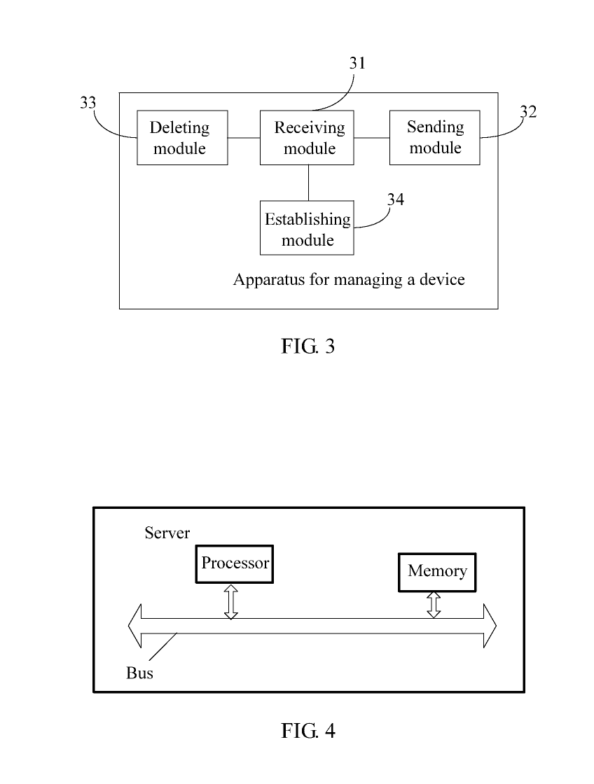

FIG. 3 is a schematic structural diagram of an apparatus for managing a device according to an embodiment of the present invention. As shown in FIG. 3, the apparatus for managing a device in this embodiment is located on a server side, a binding relationship between the device and transferor information of the device is stored in a server, and the apparatus specifically includes a receiving module 31, configured to receive a device transfer request message, where the device transfer request message includes transferee information of the device and information about the device, and a sending module 32, configured to send a to-be-transferred instruction to the device according to the device transfer request message, where the to-be-transferred instruction includes the transferee information of the device; the to-be-transferred instruction is used to instruct the device to set an activated state of the device to a to-be-activated state; and after the device is set to the to-be-activated state, the device can be activated only by using specified user information, where the specified user information includes the transferor information of the device and/or the transferee information of the device.

Optionally, the receiving module 31 is further configured to receive a first activation request message sent by the device, where the first activation request message includes the transferee information of the device and the information about the device, and the apparatus further includes a deleting module 33, configured to delete, according to the first activation request message, the binding relationship between the device and the transferor information of the device stored in the server, and an establishing module 34, configured to establish a binding relationship between the device and the transferee information of the device according to the first activation request message.

Optionally, the sending module 32 is further configured to send a first activation instruction to the device, where the first activation instruction is used to instruct the device to delete user data of a transferor of the device saved in the device and use the transferee information of the device to activate the device.

Optionally, the receiving module 31 is further configured to receive a second activation request message sent by the device, where the second activation request message includes the transferor information of the device and the information about the device, and the sending module 32 is further configured to send a second activation instruction to the device, where the second activation instruction is used to instruct the device to use the transferor information of the device to activate the device.

Optionally, the sending module 32 is further configured to send, according to the transferee information of the device, a transfer acknowledgement request message to a terminal of a transferee to which the transferee information points, so that the terminal of the transferee sends a transfer acknowledgement response message to the server, and the sending module 32 is further configured to send the to-be-transferred instruction to the device according to the transfer acknowledgement response message.

The apparatus described in this embodiment of the present invention may execute the method described in the embodiment shown in FIG. 1. For technical implementation processes and technical effects, reference may be made to detailed content in the embodiment shown in FIG. 1, and details are not described herein again.

FIG. 4 is a schematic structural diagram of a server according to an embodiment of the present invention. A binding relationship between a device and transferor information of the device is stored in the server in this embodiment. As shown in FIG. 4, the server includes a processor and a memory, where the processor and the memory are connected by using a communications bus; an instruction for implementing the method for managing a device in the embodiment shown in FIG. 1 is stored in the memory; and the processor may invoke the instruction in the memory to execute the method for managing a device in the embodiment shown in FIG. 1.

The apparatus described in this embodiment of the present invention may execute the method described in the embodiment shown in FIG. 1. For technical implementation processes and technical effects, reference may be made to detailed content in the embodiment shown in FIG. 1, and details are not described herein again.

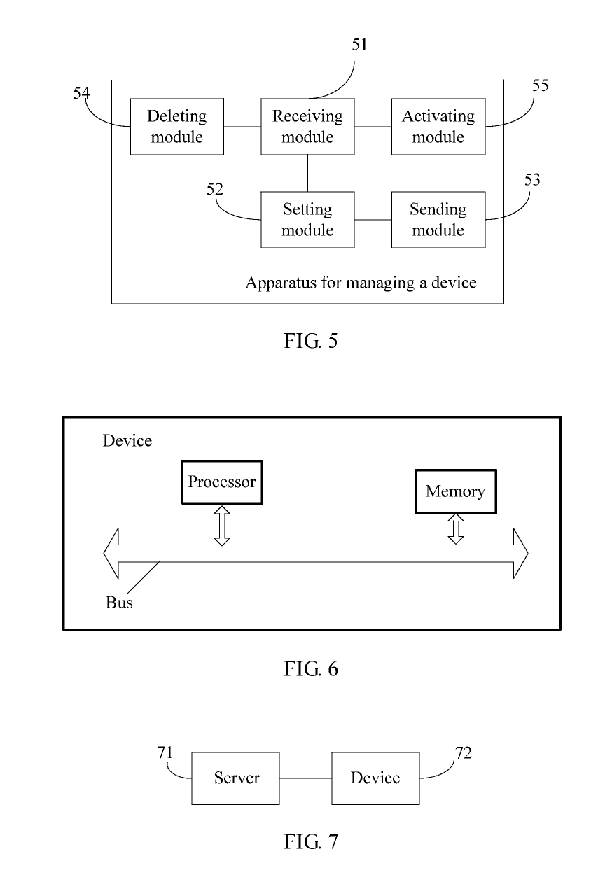

FIG. 5 is a schematic structural diagram of an apparatus for managing a device according to an embodiment of the present invention. The apparatus for managing a device in this embodiment is located on a device side and a binding relationship between the device and transferor information of the device is stored in a server in this embodiment. As shown in FIG. 5, the apparatus includes a receiving module 51, configured to receive a to-be-transferred instruction sent by the server, where the to-be-transferred instruction includes transferee information of the device, and a setting module 52, configured to set an activated state of the device to a to-be-activated state according to the to-be-transferred instruction, where the to-be-transferred instruction is a to-be-transferred instruction that is sent by the server, after receiving a device transfer request message, to the device according to the transferee information of the device and information about the device that are included in the device transfer request message.

Optionally, the apparatus further includes a sending module 53, configured to send a first activation request message to the server, where the first activation request message includes the transferee information of the device and the information about the device, so that the server deletes, according to the first activation request message, the binding relationship between the device and the transferor information of the device stored in the server, and establishes a binding relationship between the device and the transferee information of the device according to the first activation request message.

Optionally, the receiving module 51 is further configured to receive a first activation instruction sent by the server, and the apparatus further includes a deleting module 54, configured to delete, according to the first activation instruction, user data of a transferor of the device saved in the device, and an activating module 55, configured to use, according to the first activation instruction, the transferee information of the device to activate the device.

Optionally, the sending module 53 is further configured to send a second activation request message to the server, where the second activation request message includes the transferor information of the device and the information about the device, so that the server sends a second activation instruction to the device, where the second activation instruction is used to instruct the device to use the transferor information of the device to activate the device, and the activating module 55 is further configured to use, according to the second activation instruction, the transferor information of the device to activate the device.

The apparatus described in this embodiment of the present invention may execute the method described in the embodiment shown in FIG. 1. For technical implementation processes and technical effects, reference may be made to detailed content in the embodiment shown in FIG. 1, and details are not described herein again.

FIG. 6 is a schematic structural diagram of a device according to an embodiment of the present invention. As shown in FIG. 6, the device includes a processor and a memory, where the processor and the memory are connected by using a communications bus; an instruction for implementing the method for managing a device in the embodiment shown in FIG. 1 is stored in the memory; and the processor may invoke the instruction in the memory to execute the method for managing a device in the embodiment shown in FIG. 1.

The apparatus described in this embodiment of the present invention may execute the method described in the embodiment shown in FIG. 1. For technical implementation processes and technical effects, reference may be made to detailed content in the embodiment shown in FIG. 1, and details are not described herein again.

FIG. 7 is a schematic structural diagram of a system for managing a device according to an embodiment of the present invention. As shown in FIG. 7, the system includes a server 71 and a device 72 that is connected to the server 71, where the server includes the apparatus for managing a device in the embodiment shown in FIG. 3, and the device includes the apparatus for managing a device in the embodiment shown in FIG. 5.

The system described in this embodiment of the present invention may execute the method described in the embodiment shown in FIG. 1. For technical implementation processes and technical effects, reference may be made to detailed content in the embodiment shown in FIG. 1, and details are not described herein again.

It may be clearly understood by persons skilled in the art that, for the purpose of convenient and brief description, for a specific working process of the foregoing system, apparatus, and unit, reference may be made to a corresponding process in the foregoing method embodiments, and details are not described herein again.

In the several embodiments provided in the present application, it should be understood that the disclosed system, apparatus, and method may be implemented in other manners. For example, the described apparatus embodiment is merely exemplary. For example, the unit division is merely logical function division or may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, functional units in the embodiments of the present invention may be integrated into one processing unit, or each of the units may exist alone physically, or two or more units may be integrated into one unit. The integrated unit may be implemented in a form of hardware, or may be implemented in a form of hardware in addition to a software functional unit.

When the foregoing integrated unit is implemented in a form of a software functional unit, the integrated unit may be stored in a computer-readable storage medium. The foregoing software functional unit is stored in a storage medium and includes several instructions for instructing a computer device (which may be a personal computer, a server, or a network device) to perform some of the steps of the methods described in the embodiments of the present invention. The foregoing storage medium includes: any medium that can store program code, such as a removable hard disk, a read-only memory (ROM), a random access memory (RAM), a magnetic disk, or an optical disc.

Finally, it should be noted that the foregoing embodiments are merely intended for describing the technical solutions of the present invention, but not for limiting the present invention. Although the present invention is described in detail with reference to the foregoing embodiments, persons of ordinary skill in the art should understand that they may still make modifications to the technical solutions described in the foregoing embodiments or make equivalent replacements to some technical features thereof; however, these modifications or replacements do not make the essence of corresponding technical solutions depart from the protection scope of the technical solutions in the embodiments of the present invention.

### Embodiment 1

A method for managing a device, wherein a binding relationship between the device and transferor information of the device is stored in a server, and the method comprises receiving, by the server, a device transfer request message, wherein the device transfer request message comprises transferee information of the device and information about the device, and sending, by the server, a to-be-transferred instruction to the device according to the device transfer request message, wherein the to-be-transferred instruction comprises the transferee information of the device; the to-be-transferred instruction is used to instruct the device to set an activated state of the device to a to-be-activated state; and after the device is set to the to-be-activated state, the device can be activated only by using specified user information, wherein the specified user information comprises the transferor information of the device and/or the transferee information of the device.

### Embodiment 2

The method according to embodiment 1, wherein after the sending, by the server, a to-be-transferred instruction to the device according to the device transfer request message, the method further comprises receiving, by the server, a first activation request message sent by the device, wherein the first activation request message comprises the transferee information of the device and the information about the device, and deleting, by the server according to the first activation request message, the binding relationship between the device and the transferor information of the device stored in the server, and establishing, by the server, a binding relationship between the device and the transferee information of the device according to the first activation request message.

### Embodiment 3

The method according to embodiment 2, wherein after the establishing, by the server, a binding relationship between the device and the transferee information of the device, the method further comprises sending, by the server, a first activation instruction to the device, wherein the first activation instruction is used to instruct the device to delete user data of a transferor of the device saved in the device and use the transferee information of the device to activate the device.

### Embodiment 4

The method according to embodiment 1, wherein after the sending, by the server, a to-be-transferred instruction to the device according to the device transfer request message, the method further comprises receiving, by the server, a second activation request message sent by the device, wherein the second activation request message comprises the transferor information of the device and the information about the device, and sending, by the server, a second activation instruction to the device, wherein the second activation instruction is used to instruct the device to use the transferor information of the device to activate the device.

### Embodiment 5

The method according to any one of embodiments 1 to 4, wherein the sending, by the server, a to-be-transferred instruction to the device according to the device transfer request message comprises sending, by the server according to the transferee information of the device, a transfer acknowledgement request message to a terminal of a transferee to which the transferee information points, so that the terminal of the transferee sends a transfer acknowledgement response message to the server, and sending, by the server, the to-be-transferred instruction to the device according to the transfer acknowledgement response message.

### Embodiment 6

An apparatus for managing a device, wherein the apparatus is located on a server side, a binding relationship between the device and transferor information of the device is stored in a server, and the apparatus comprises a receiving module, configured to receive a device transfer request message, wherein the device transfer request message comprises transferee information of the device and information about the device, and a sending module, configured to send a to-be-transferred instruction to the device according to the device transfer request message, wherein the to-be-transferred instruction comprises the transferee information of the device; the to-be-transferred instruction is used to instruct the device to set an activated state of the device to a to-be-activated state; and after the device is set to the to-be-activated state, the device can be activated only by using specified user information, wherein the specified user information comprises the transferor information of the device and/or the transferee information of the device.

### Embodiment 7

The apparatus according to embodiment 6, wherein the receiving module is further configured to receive a first activation request message sent by the device, wherein the first activation request message comprises the transferee information of the device and the information about the device, and the apparatus further comprises a deleting module, configured to delete, according to the first activation request message, the binding relationship between the device and the transferor information of the device stored in the server, and an establishing module, configured to establish a binding relationship between the device and the transferee information of the device according to the first activation request message.

### Embodiment 8

The apparatus according to embodiment 7, wherein the sending module is further configured to send a first activation instruction to the device, wherein the first activation instruction is used to instruct the device to delete user data of a transferor of the device saved in the device and use the transferee information of the device to activate the device.

### Embodiment 9

The apparatus according to embodiment 6, wherein the receiving module is further configured to receive a second activation request message sent by the device, wherein the second activation request message comprises the transferor information of the device and the information about the device, and the sending module is further configured to send a second activation instruction to the device, wherein the second activation instruction is used to instruct the device to use the transferor information of the device to activate the device.

### Embodiment 10

The apparatus according to any one of embodiments 6 to 9, wherein the sending module is further configured to send, according to the transferee information of the device, a transfer acknowledgement request message to a terminal of a transferee to which the transferee information points, so that the terminal of the transferee sends a transfer acknowledgement response message to the server, and the sending module is further configured to send the to-be-transferred instruction to the device according to the transfer acknowledgement response message.

### Embodiment 11

An apparatus for managing a device, wherein the apparatus is located on a server side, a binding relationship between the device and transferor information of the device is stored in a server, and the apparatus comprises a processor and a memory, wherein the processor and the memory are connected by using a communications bus; an instruction for implementing the method for managing a device according to any one of embodiments 1 to 5 is saved in the memory; and the processor may invoke the instruction in the memory to execute the method for managing a device according to any one of embodiments 1 to 5.

### Embodiment 12

A method for managing a device, wherein a binding relationship between the device and transferor information of the device is stored in a server, and the method comprises receiving, by the device, a to-be-transferred instruction sent by the server, wherein the to-be-transferred instruction comprises transferee information of the device, and setting, by the device, an activated state of the device to a to-be-activated state according to the to-be-transferred instruction, wherein the to-be-transferred instruction is a to-be-transferred instruction that is sent by the server, after receiving a device transfer request message, to the device according to the transferee information of the device and information about the device that are comprised in the device transfer request message.

### Embodiment 13

The method according to embodiment 12, wherein after the setting, by the device, an activated state of the device to a to-be-activated state, the method comprises sending, by the device, a first activation request message to the server, wherein the first activation request message comprises the transferee information of the device and the information about the device, so that the server deletes, according to the first activation request message, the binding relationship between the device and the transferor information of the device stored in the server, and establishes a binding relationship between the device and the transferee information of the device according to the first activation request message.

### Embodiment 14

The method according to embodiment 13, further comprising receiving, by the device, a first activation instruction sent by the server, and deleting, by the device according to the first activation instruction, user data of a transferor of the device saved in the device, and using, according to the first activation instruction, the transferee information of the device to activate the device.

### Embodiment 15

The method according to embodiment 12, wherein after the setting, by the device, an activated state of the device to a to-be-activated state, the method further comprises sending, by the device, a second activation request message to the server, wherein the second activation request message comprises the transferor information of the device and the information about the device, so that the server sends a second activation instruction to the device, wherein the second activation instruction is used to instruct the device to use the transferor information of the device to activate the device, and using, by the device according to the second activation instruction, the transferor information of the device to activate the device.

### Embodiment 16

An apparatus for managing a device, wherein the apparatus is located on a device side, a binding relationship between the device and transferor information of the device is stored in a server, and the apparatus comprises a receiving module, configured to receive a to-be-transferred instruction sent by the server, wherein the to-be-transferred instruction comprises transferee information of the device; and a setting module, configured to set an activated state of the device to a to-be-activated state according to the to-be-transferred instruction, wherein the to-be-transferred instruction is a to-be-transferred instruction that is sent by the server, after receiving a device transfer request message, to the device according to the transferee information of the device and information about the device that are comprised in the device transfer request message.

### Embodiment 17

The apparatus according to embodiment 16, further comprising a sending module, configured to send a first activation request message to the server, wherein the first activation request message comprises the transferee information of the device and the information about the device, so that the server deletes, according to the first activation request message, the binding relationship between the device and the transferor information of the device stored in the server, and establishes a binding relationship between the device and the transferee information of the device according to the first activation request message.

### Embodiment 18

The apparatus according to embodiment 17, wherein the receiving module is further configured to receive a first activation instruction sent by the server, and the apparatus further comprises a deleting module, configured to delete, according to the first activation instruction, user data of a transferor of the device saved in the device, and an activating module, configured to use, according to the first activation instruction, the transferee information of the device to activate the device.

### Embodiment 19

The apparatus according to embodiment 16, wherein the sending module is further configured to send a second activation request message to the server, wherein the second activation request message comprises the transferor information of the device and the information about the device, so that the server sends a second activation instruction to the device, wherein the second activation instruction is used to instruct the device to use the transferor information of the device to activate the device; and the activating module is further configured to use, according to the second activation instruction, the transferor information of the device to activate the device.

### Embodiment 20

An apparatus for managing a device, wherein the apparatus is located on a device side, a binding relationship between the device and transferor information of the device is stored in a server, and the apparatus comprises a processor and a memory, wherein the processor and the memory are connected by using a communications bus; an instruction for implementing the method for managing a device according to any one of embodiments 12 to 15 is saved in the memory; and the processor may invoke the instruction in the memory to execute the method for managing a device according to any one of embodiments 12 to 15.

### Embodiment 21

A system for managing a device comprises a server and a device that is connected to the server, wherein the server comprises the apparatus for managing a device according to any one of embodiments 6 to 10, and the device comprises the apparatus for managing a device according to any one of embodiments 16 to 19.

What is claimed is:

1. A method for managing a device, wherein a binding relationship between the device and transferor information of the device is stored in a server, and the method comprises:
receiving, by the server, a device transfer request message, wherein the device transfer request message comprises transferee information of the device and information about the device; and
sending, by the server, a to-be-transferred instruction to the device according to the device transfer request message,
wherein the to-be-transferred instruction comprises the transferee information of the device,
wherein the to-be-transferred instruction is used to instruct the device to set an activated state of the device to a to-be-activated state, and
wherein after the device is set to the to-be-activated state, the device can be activated only by using specified user information.

2. The method according to claim 1, wherein the specified user information comprises the transferor information of the device.

3. The method according to claim 1, wherein the specified user information comprises the transferee information of the device.

4. The method according to claim 1, wherein the specified user information comprises the transferor information of the device and the transferee information of the device.

5. The method according to claim 1, wherein after sending, by the server, the to-be-transferred instruction to the device according to the device transfer request message, the method further comprises:
receiving, by the server, a first activation request message sent by the device, wherein the first activation request message comprises the transferee information of the device and the information about the device;
deleting, by the server according to the first activation request message, the binding relationship between the device and the transferor information of the device stored in the server; and
establishing, by the server, a binding relationship between the device and the transferee information of the device according to the first activation request message.

6. The method according to claim 5, wherein after establishing, by the server, the binding relationship between the device and the transferee information of the device, the method further comprises sending, by the server, a first activation instruction to the device, wherein the first activation instruction is used to instruct the device to delete user data of a transferor of the device saved in the device and use the transferee information of the device to activate the device.

7. The method according to claim 1, wherein after sending, by the server, the to-be-transferred instruction to the device according to the device transfer request message, the method further comprises:
receiving, by the server, a second activation request message sent by the device, wherein the second activation request message comprises the transferor information of the device and the information about the device; and
sending, by the server, a second activation instruction to the device, wherein the second activation instruction is used to instruct the device to use the transferor information of the device to activate the device.

8. The method according to claim 1, wherein sending, by the server, the to-be-transferred instruction to the device according to the device transfer request message comprises:
sending, by the server according to the transferee information of the device, a transfer acknowledgement request message to a terminal of a transferee to which the transferee information points such that the terminal of the transferee sends a transfer acknowledgement response message to the server; and
sending, by the server, the to-be-transferred instruction to the device according to the transfer acknowledgement response message.

9. An apparatus for managing a device, wherein the apparatus is located on a server side, a binding relationship between the device and transferor information of the device is stored in a server, and the apparatus comprises:
a processor; and
a memory,
wherein the processor and the memory are connected by using a communications bus,
wherein instructions are stored in the memory, and
wherein the instructions are executed by the processor to:
receive a device transfer request message, wherein the device transfer request message comprises transferee information of the device and information about the device; and
send a to-be-transferred instruction to the device according to the device transfer request message,
wherein the to-be-transferred instruction comprises the transferee information of the device,
wherein the to-be-transferred instruction is used to instruct the device to set an activated state of the device to a to-be-activated state, and
wherein after the device is set to the to-be-activated state, the device can be activated only by using specified user information.

10. The apparatus according to claim 9, wherein the specified user information comprises the transferor information of the device.

11. The apparatus according to claim 9, wherein the specified user information comprises the transferee information of the device.

12. The apparatus according to claim 9, wherein the specified user information comprises the transferor information of the device and the transferee information of the device.

13. The apparatus according to claim 9, wherein the instructions are executed by the processor to:
receive, a first activation request message sent by the device after sending the to-be-transferred instruction to the device, wherein the first activation request message comprises the transferee information of the device and the information about the device;
delete, according to the first activation request message, the binding relationship between the device and the transferor information of the device stored in the server; and
establish, by the server, a binding relationship between the device and the transferee information of the device according to the first activation request message.

14. The apparatus according to claim 13, wherein the instructions are executed by the processor to send a first activation instruction to the device after establishing the binding relationship, wherein the first activation instruction is used to instruct the device to delete user data of a transferor of the device saved in the device and use the transferee information of the device to activate the device.

15. The apparatus according to claim 9, wherein the instructions are executed by the processor to:
receive a second activation request message sent by the device after sending the to-be-transferred instruction to the device, wherein the second activation request message comprises the transferor information of the device and the information about the device; and
send a second activation instruction to the device, wherein the second activation instruction is used to instruct the device to use the transferor information of the device to activate the device.

16. The apparatus according to claim 9, wherein sending the to-be-transferred instruction to the device according to the device transfer request message comprises:
sending according to the transferee information of the device, a transfer acknowledgement request message to a terminal of a transferee to which the transferee information points such that the terminal of the transferee sends a transfer acknowledgement response message to the server; and
sending the to-be-transferred instruction to the device according to the transfer acknowledgement response message.

17. A method for managing a device, wherein a binding relationship between the device and transferor information of the device is stored in a server, and the method comprises:
receiving, by the device, a to-be-transferred instruction sent by the server, wherein the to-be-transferred instruction comprises transferee information of the device; and
setting, by the device, an activated state of the device to a to-be-activated state according to the to-be-transferred instruction,
wherein the to-be-transferred instruction is a to-be-transferred instruction that is sent by the server, after receiving a device transfer request message, to the device according to the transferee information of the device and information about the device that are comprised in the device transfer request message.

18. The method according to claim 17, wherein after setting, by the device, the activated state of the device to the to-be-activated state, the method comprises sending, by the device, a first activation request message to the server, wherein the first activation request message comprises the transferee information of the device and the information about the device such that the server deletes, according to the first activation request message, the binding relationship between the device and the transferor information of the device stored in the server, and establishes a binding relationship between the device and the transferee information of the device according to the first activation request message.

19. The method according to claim 18, further comprising:
receiving, by the device, a first activation instruction sent by the server;
deleting, by the device according to the first activation instruction, user data of a transferor of the device saved in the device; and
using, according to the first activation instruction, the transferee information of the device to activate the device.

20. The method according to claim 17, wherein after setting, by the device, the activated state of the device to the to-be-activated state, the method further comprises:
sending, by the device, a second activation request message to the server, wherein the second activation request message comprises the transferor information of the device and the information about the device such that the server sends a second activation instruction to the device, wherein the second activation instruction is used to instruct the device to use the transferor information of the device to activate the device; and
using, by the device according to the second activation instruction, the transferor information of the device to activate the device.
